(19) United States
(12) Patent Application Publication
(10) Pub. No.: US 2007/0291116 A1
(43) Pub. Date: Dec. 20, 2007

(54) TRAFFIC MONITORING DEVICE FOR VEHICLES

(76) Inventor: Luis CREUS SOLA, Barcelona (ES)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/762,800

(22) Filed: Jun. 14, 2007

(30) Foreign Application Priority Data
Jun. 14, 2006 (ES) U 200601399

(51) Int. Cl. H04N 7/18

(52) U.S. Cl. 348/149; 348/159

(57) ABSTRACT

A traffic monitoring device for vehicles, comprising first and second mini-cameras, mounted behind the windshield and the rear window of the vehicle to view the traffic to the front of the vehicle and to the rear of the vehicle, respectively, a recorder-player within the vehicle and connected to the mini-cameras and the vehicle battery, and switches, when activated, causing each recorder-player to record any incidents which occur in the view of the mini-camera while the vehicle is in motion. The recorder-player preferably has a split viewing screen capable off displaying the images from the first and second mini-cameras simultaneously and/or sequentially.

### FIELD OF INVENTION

This invention relates to a device which has been especially devised for its incorporation in an automobile, and which monitors and records the incidents which may occur in the vicinity of said vehicle while the same is in motion.

The device likewise permits monitoring by recording while the vehicle is stationary, in order to detect possible theft in car parks and garages, in particular to verify, by means of recording, the criminals who carry out the theft.

More specifically, and in accordance with the essential nature of the invention, the object of the same is to record possible faults and accidents which may take place in the vicinity of the vehicle, in order to be able to determine subsequently and with total reliability who was responsible for said incidents, for example in order to establish responsibilities for accident insurance companies.

### BACKGROUND OF THE INVENTION

During the course of normal vehicle traffic, the occurrence of accidents of greater or lesser seriousness is frequent, sometimes caused fortuitously, at other times due to mistakes made by the drivers, and more frequently due to the carrying out of forbidden or dangerous maneuvers.

The tendency of the majority of drivers to hold the other party, that is, the other vehicle involved in the accident, responsible for the same is well known.

On many occasions the results of the impact on the bodywork of the vehicles, the marks made by the tires on the road surface, etc, allow the establishment of the appropriate responsibility, but apart from the fact that this always causes problems, there are cases in which it is not possible to determine by these means who was responsible for the accident, and therefore the only solution is to have recourse to eye-witnesses, and as is well known, said eye-witnesses tend to disappear due to the problems of wasting time which acting as said witness habitually involves.

### SUMMARY OF THE INVENTION

The device proposed by the invention solves the problems stated above in a totally satisfactory manner, as it carries out a real-time recording of the surroundings of the vehicle, in such a way that by means of the same any person, for example a claims adjuster, may subsequently determine easily and rapidly who is responsible for the accident.

In order to do this, and more specifically, the device which is the object of this invention incorporates at least one, and preferably two, mini-cameras, intended to be placed at strategic points of the vehicle, such as at the front windshield and at the rear window, and facing in suitable directions.

These mini-cameras are connected to a recording-playback device, which in turn may be located in any suitable place in the vehicle, such as in the luggage compartment; the recording-playback device receives power from the battery of the vehicle and incorporates at least one switch; preferably one for each mini-camera, whose function it is to activate the recorder. The connection between mini-cameras and recorder may be made by cables, or with a wireless connection.

On the screen of said recorder, located preferably on the dashboard of the vehicle, the images captured by the mini-cameras may be viewed at all times, by means of control buttons, either simultaneously, said screen being divided into two halves for the viewing of both images, or the images captured by first one mini-camera and then the other may be viewed sequentially.

The recorder will also be of the type which automatically inserts the hour and date at all times.

In this way, when an accident takes place in the vicinity of the vehicle which bears the device, and irrespective of whether said vehicle is involved in the accident or not, the latter will have been recorded so that, for example, the claims adjuster of an insurance company has at his/her disposal information which coincides practically with that which he/she would have if he/she had been a direct witness of the accident.

### DESCRIPTION OF THE DRAWINGS

To complement the description which is being made, and with the purpose of contributing to a better understanding of the characteristics of the invention, in accordance with a preferred embodiment of the same, a set of drawings with an illustrative and non-limitative character is attached as an integral part of said description, in which the following is portrayed:

FIG. 1 portrays a schematic side elevational view of a vehicle equipped with the traffic monitoring device which is the object of this invention;

FIG. 2 portrays a diagram of said device.

### DESCRIPTION OF THE PREFERRED EMBODIMENT

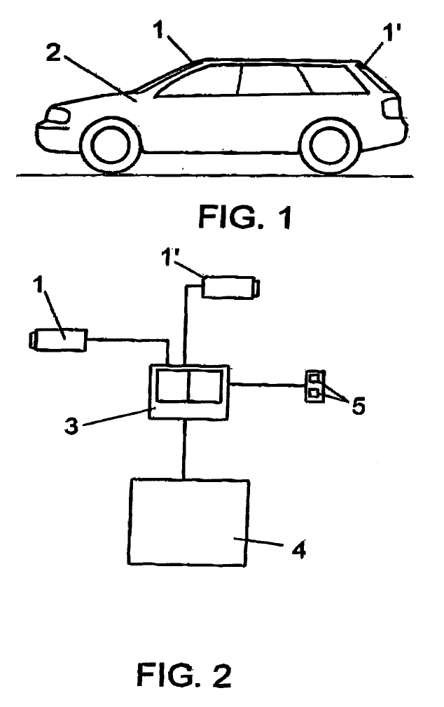

On viewing the drawings disclosed, it may be seen that the monitoring device proposed by the invention is comprised of two mini-cameras (1, 1′), intended to be suitably located in the interior of an automobile (2), for example as may be seen in the embodiment in FIG. 1, at the front windshield, camouflaged between the latter and the rear-view mirror, and at the rear window, in a position where it will not be an impediment to driving by reducing the visibility of the driver of the vehicle.

As has already been mentioned, the device may feature a single mini-camera, such as the front mini-camera (1), while not featuring the rear camera or, conversely, it may feature a number of cameras greater than two, without this affecting the essence of the invention.

In any case, the cameras (1, 1′) are connected to a recorder (3), supplied with power by the electrical system of the vehicle, specifically connected directly or indirectly to the battery of the same, and said recorder, which, as has been mentioned above, is also a player, receives the power from the battery (4) through at least one switch (5), preferably one switch for each mini-camera (1, 1′).

In accordance with this structuring of the recorder (3), information regarding everything which occurs in front of the vehicle (2), captured by the mini-camera (1), is stored; likewise whatever occurs behind the vehicle, captured in turn by the mini-camera (1′); said images being accompanied, as has been mentioned above, by data regarding the day, hour and minute at which the recording is taking place; in this way, the information capable of being provided by the device in the event of an accident is optimal.

1. A traffic monitoring device for vehicles, characterised in that it is comprised of at least one mini-camera, intended to be conveniently fixed behind the windshield of the vehicle; this mini-camera feeds a recorder-player, locatable in any suitable place within the vehicle, whose power is supplied by the battery of the vehicle via the activating switch of the same; all of the above in such a way that the aforementioned mini-camera records the incidents which may occur in front of the vehicle while the same is in motion.

2. A traffic monitoring device for vehicles, according to claim 1, characterised in that the same comprises preferably two mini-cameras, one located behind the front windshield and the other behind the rear window.

3. A traffic monitoring device for vehicles, according to claim 2 characterised in that the recorder allows the simultaneous viewing of the images of both mini-cameras by means of the establishment of a split screen on the same, and allow viewing of said images sequentially, the number of switches being the same as the number of mini-cameras connected to the recorder-player.

4. A traffic monitoring device for vehicles having a battery, comprising at least one mini-camera, adapted to be mounted behind the windshield of the vehicle; a recorder-player within the vehicle and connected to said mini-camera, and electrical connections including an activating switch connecting the recorder-player to the vehicle battery; said switch, when activated, causing said recorder-player to record any incidents which occur in the view of said mini-camera vehicle while the vehicle is in motion.

5. A traffic monitoring system according to claim 4 wherein said at least one mini-camera is mounted in a position to view the traffic to the front of the vehicle, and including a second mini-camera mounted in a position to view the traffic to the rear of the vehicle, said recorder player having a split viewing screen capable off displaying the images from said first and second mini-cameras simultaneously and/or sequentially.
